(19) United States
(12) Patent Application Publication
(10) Pub. No.: US 2011/0169195 A1
(43) Pub. Date: Jul. 14, 2011

(54) MOLDING APPARATUS AND MOLDING METHOD

(76) Inventor: Cheol-joon YOO, Hwaseong-si (KR)

(21) Appl. No.: 12/962,966

(22) Filed: Dec. 8, 2010

(30) Foreign Application Priority Data
Jan. 11, 2010 (KR) 10-2010-0002386

(51) Int. Cl. B29C 45/03; B29C 45/00

(52) U.S. Cl. 264/328.1; 425/542

(57) ABSTRACT

Provided are a molding apparatus and a molding method. The molding apparatus a mold including a cavity and a runner. The molding apparatus may further include a pot connected to the runner of the mold, wherein a fluid resin is contained in the pot The molding apparatus may further include a compression gas injection unit configured to inject a compression gas into the pot such that the fluid resin contained in the pot is transferred to the cavity and the runner.

### CROSS-REFERENCE TO RELATED APPLICATIONS

This application claims priority under 35 U.S.C. §119 from Korean Patent Application No. 10-2010-0002386, filed on Jan. 11, 2010, in the Korean Intellectual Property Office, the disclosure of which is incorporated herein in its entirety by reference.

### BACKGROUND

Example embodiments of the inventive concepts relate to a molding apparatus and molding methods, and more particularly, to a molding apparatus and a molding method whereby a fluid resin that can easily flow is transferred to a cavity by using a gas pressure of, for example, air.

In general, a semiconductor package is mounted on a circuit substrate and sealed thereon by using a thermosetting resin in order to protect a semiconductor chip from at least an external impact or pollutant materials.

In order to harden the thermosetting resin that covers the semiconductor chip, a molding apparatus having a mold formed of a top die and a bottom die that clamp to each other so as to form a cavity and a runner therein has been widely used.

A conventional molding apparatus may include a pot connected to a runner in the mold so as to melt the thermosetting resin into the cavity, and a fused resin is pressed into the pot via a piston-shaped plunger.

As a height of a semiconductor package has been gradually lowered or decreased and a stack number of semiconductor chips stacked inside the semiconductor package has increased, the development of a resin having high fluidity and capable of penetrating the cavity is desired or required.

Also, the development of such a resin is further desired or required as the risk of damaging the chips has increased at least due to a difference in pressures of the resin penetrating the cavity.

It is beneficial or essential to reduce the viscosity of the material of the high fluidity resin. Additionally, a molding apparatus and a molding method for molding a low-viscosity fluid resin is desired or required due to the development of such low-viscosity fluid resin.

### SUMMARY

Embodiments of the inventive concepts provide molding apparatuses and a molding methods capable of molding a strong molding product by transporting and compressing a liquid or gel-type fluid resin into a cavity formed in a mold by using high pressure gas.

Embodiments of the inventive concepts also provide a molding apparatus and a molding method capable of quickly and easily transferring a fluid resin when injecting the fluid resin in a mold cavity by forming a vacuum pressure in a double-fold manner inside the mold cavity, to thereby increase molding productivity.

Embodiments of the inventive concepts also provide a molding apparatus and a molding method capable of manufacturing a dense, high quality molding product by maintaining a constantly high gas pressure when hardening a fluid resin.

Embodiments of the inventive concepts also provide a molding apparatus and a molding method capable of precisely adjusting a transfer speed of a fluid resin by adjusting a gas pressure when transferring the fluid resin to a mold cavity.

According to an aspect of the embodiments of the inventive concepts, there are provided a molding apparatus comprising: a mold including a first die and a second die that are clamped to each other such that a cavity and a runner are formed in the mold; a pot that is formed to be connected to the runner of the mold, wherein a fluid resin is contained in the pot; and a compression gas injection unit that injects a compression gas into the pot such that the fluid resin contained in the pot is transferred to the cavity and the runner due to a gas pressure.

In accordance with another example embodiment of the inventive concepts, a molding apparatus may include a mold including a cavity and a runner. The molding apparatus may also include a pot connected to the runner of the mold, wherein a fluid resin is contained in the pot. The molding apparatus may further include a compression gas injection device configured to inject a compression gas into the pot such that the fluid resin contained in the pot is transferred to the cavity and the runner due to a gas pressure.

The compression gas injection unit may include a compression gas supply pipe that is connected to the pot so as to supply a compression gas into the pot. The compression gas injection unit may further include a compression gas supply valve that is installed at the compression gas supply pipe and selectively supplies a compression gas. Also, the compression gas injection unit may include a compression gas storage that is connected to the compression gas supply pipe and stores compression gas. Additionally, the compression gas injection unit may further include a control unit that applies a control signal to the compression gas supply valve according to a program or a compression gas supply command.

The molding apparatus may further include fluid resin supply unit that supplies a fluid resin into the pot. The fluid resin supply unit may include a fluid resin injection nozzle that is installed on the pot and injects a fluid resin into the pot, a dispenser that is connected to the fluid resin injection nozzle and supplies a fluid resin into the fluid resin injection nozzle and a control unit that applies a control signal to the dispenser according to a program or a fluid resin supply command.

The molding apparatus may further include a first vacuum pressure forming apparatus that is connected to the pot, and forms a vacuum pressure in the cavity, the runner, and the pot of the mold. The first vacuum pressure forming apparatus may include a first vacuum line that is connected to the pot so that a vacuum pressure is formed in the pot. Also, the molding apparatus may include a first vacuum line open/close valve that is installed on the first vacuum line and selectively opens/closes the first vacuum line and a first vacuum pump that is connected to the first vacuum line and generates a vacuum pressure in the first vacuum line. Furthermore, the molding apparatus may include control unit that applies a control signal to the first vacuum line open/close valve according to a program or a command for forming a first vacuum pressure.

The molding apparatus may further include a sealing member that is installed between the first die and the second die so that a vent hole formed between the first die and the second die is sealed when the first die and the second die are clamped to each other. The molding apparatus may further include a second vacuum pressure forming apparatus that is installed between the vent hole and the sealing member and forms a vacuum pressure in the cavity, the runner, and the pot of the mold through the vent hole.

The second vacuum pressure forming apparatus may include a second vacuum line that is installed between the vent hole and the sealing member so that a vacuum pressure is formed between the vent hole and the sealing member. The second vacuum pressure forming apparatus may include a second vacuum line open/close valve that is installed on the second vacuum line and selectively opens/closes the second vacuum line and a second vacuum pump that is connected to the second vacuum line and generates a vacuum pressure in the second vacuum line. Also, the second vacuum pressure forming apparatus may include a control unit that applies a control signal to the second vacuum line open/close valve according to a program or a command for forming a second vacuum pressure.

The mold may be a mold for molding semiconductors, in which a circuit board including a semiconductor chip mounted between the first die and the second die is installed.

A non-viscosity coating layer may be formed on an inner wall of the pot so that the resin is easily detached or separated from the inner wall of the pot.

According to another aspect of the embodiments of the inventive concepts, there is provided a method of molding, the method includes clamping a mold such that a first die and a second die of the mold are clamped to each other such that a cavity and a runner are formed in the mold. The method further includes supplying a fluid resin into a pot that is connected to the runner in the mold and injecting a compression gas into the pot such that the fluid resin contained in the pot is transferred to the cavity and the runner due to a gas pressure.

According to another embodiment of the inventive concepts there is a method for of molding that includes clamping a mold such that a first die and a second die of the mold are clamped to each other and a cavity and a runner are formed in the mold. The method may further include supplying a fluid resin into a pot that is connected to the runner in the mold. The method may also include injecting a compression gas into the pot such that the fluid resin contained in the pot is transferred to the cavity and the runner due.

The method may further include forming a vacuum pressure into the cavity, the runner, and the pot. The forming a vacuum pressure may include forming a first vacuum pressure into the cavity, the runner, and the pot of the mold by using a first vacuum pressure forming apparatus installed in the pot The method may also include forming a second vacuum pressure by using a second vacuum pressure forming apparatus that is installed in a vent hole formed between the first die and the second die when the first die and the second die are clamped to each other and a sealing member installed between the first die and the second die, wherein a vacuum pressure is formed through the vent hole into the cavity, the runner, and the pot formed in the mold.

The method may further comprise, after injecting the compression gas, maintaining a gas pressure in the pot until the fluid resin filled in the cavity and the runner is hardened. Also, the method may include discharging a compression gas in the pot when the fluid resin filled in the cavity and the runner is hardened; and opening the first die and the second die of the mold and separating a molded molding product from the mold.

### BRIEF DESCRIPTION OF THE DRAWINGS

Exemplary embodiments of the inventive concepts will be more clearly understood from the following detailed description taken in conjunction with the accompanying drawings in which:

FIG. 1 is a cross-sectional view illustrating a molding apparatus according to at least one embodiment of the inventive concepts;

FIG. 2 is a plan view illustrating the molding apparatus of FIG. 1;

FIG. 3 is a cross-sectional view illustrating an operation of forming a vacuum pressure in the molding apparatus of FIG. 1;

FIG. 4 is a cross-sectional view illustrating an operation of supplying a fluid resin in the molding apparatus of FIG. 1;

FIG. 5 is a cross-sectional view illustrating an operation of injecting a compression gas in the molding apparatus of FIG. 1;

FIG. 6 is an enlarged view illustrating how the compression gas in the molding apparatus of FIG. 5 works on the fluid resin;

FIG. 7 is a cross-sectional view illustrating an operation of discharging a compression gas from the molding apparatus of FIG. 1;

FIG. 8 is a cross-sectional view illustrating a molding apparatus according to at least one other embodiment of the inventive concepts; and

FIG. 9 is a block diagram illustrating a molding method according to at least one embodiment of the inventive concepts.

### DETAILED DESCRIPTION OF EXAMPLE EMBODIMENTS

Various example embodiments will now be described more fully with reference to the accompanying drawings in which some example embodiments are shown. However, specific structural and functional details disclosed herein are merely representative for purposes of describing example embodiments. Thus, the invention may be embodied in many alternate forms and should not be construed as limited to only example embodiments set forth herein. Therefore, it should be understood that there is no intent to limit example embodiments to the particular forms disclosed, but on the contrary, example embodiments are to cover all modifications, equivalents, and alternatives falling within the scope of the invention.

In the drawings, the thicknesses of layers and regions may be exaggerated for clarity, and like numbers refer to like elements throughout the description of the figures.

Although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of example embodiments. As used herein, the term “and/or” includes any and all combinations of one or more of the associated listed items.

It will be understood that, if an element is referred to as being “connected” or “coupled” to another element, it can be directly connected, or coupled, to the other element or intervening elements may be present. In contrast, if an element is referred to as being “directly connected” or “directly coupled” to another element, there are no intervening elements present. Other words used to describe the relationship between elements should be interpreted in a like fashion (e.g., “between” versus “directly between,” “adjacent” versus “directly adjacent,” etc.).

The terminology used herein is for the purpose of describing particular embodiments only and is not intended to be limiting of example embodiments. As used herein, the singular forms “a,” “an” and “the” are intended to include the plural forms as well, unless the context clearly indicates otherwise. It will be further understood that the terms “comprises,” “comprising,” “includes” and/or “including,” if used herein, specify the presence of stated features, integers, steps, operations, elements and/or components, but do not preclude the presence or addition of one or more other features, integers, steps, operations, elements, components and/or groups thereof.

Spatially relative terms (e.g., “beneath,” “below,” “lower,” “above,” “upper” and the like) may be used herein for ease of description to describe one element or a relationship between a feature and another element or feature as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, for example, the term “below” can encompass both an orientation that is above, as well as, below. The device may be otherwise oriented (rotated 90 degrees or viewed or referenced at other orientations) and the spatially relative descriptors used herein should be interpreted accordingly.

Example embodiments are described herein with reference to cross-sectional illustrations that are schematic illustrations of idealized embodiments (and intermediate structures). As such, variations from the shapes of the illustrations as a result, for example, of manufacturing techniques and/or tolerances, may be expected. Thus, example embodiments should not be construed as limited to the particular shapes of regions illustrated herein but may include deviations in shapes that result, for example, from manufacturing. For example, an implanted region illustrated as a rectangle may have rounded or curved features and/or a gradient (e.g., of implant concentration) at its edges rather than an abrupt change from an implanted region to a non-implanted region. Likewise, a buried region formed by implantation may result in some implantation in the region between the buried region and the surface through which the implantation may take place. Thus, the regions illustrated in the figures are schematic in nature and their shapes do not necessarily illustrate the actual shape of a region of a device and do not limit the scope.

It should also be noted that in some alternative implementations, the functions/acts noted may occur out of the order noted in the figures. For example, two figures shown in succession may in fact be executed substantially concurrently or may sometimes be executed in the reverse order, depending upon the functionality/acts involved.

Unless otherwise defined, all terms (including technical and scientific terms) used herein have the same meaning as commonly understood by one of ordinary skill in the art to which example embodiments belong. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

In order to more specifically describe example embodiments, various aspects will be described in detail with reference to the attached drawings. However, the present invention is not limited to example embodiments described.

Hereinafter, preferred embodiments of the inventive concepts will be described with reference to the attached drawings.

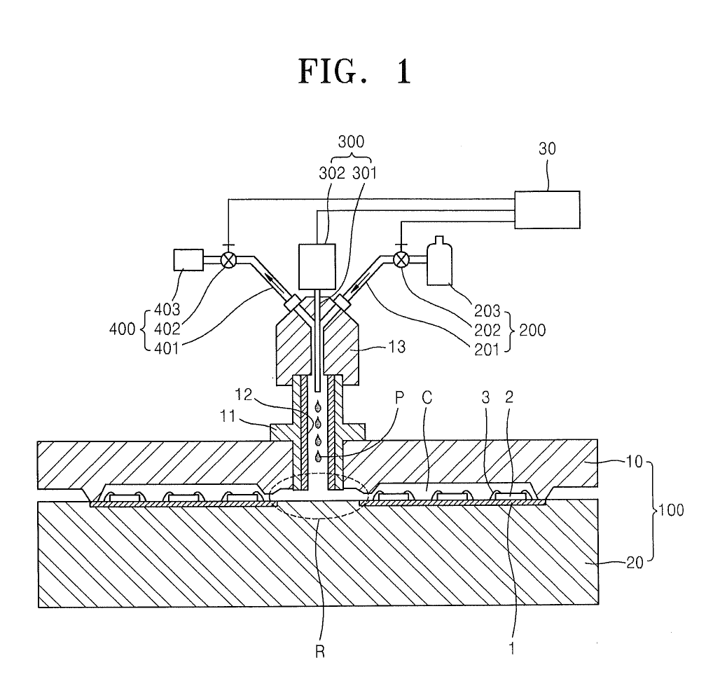

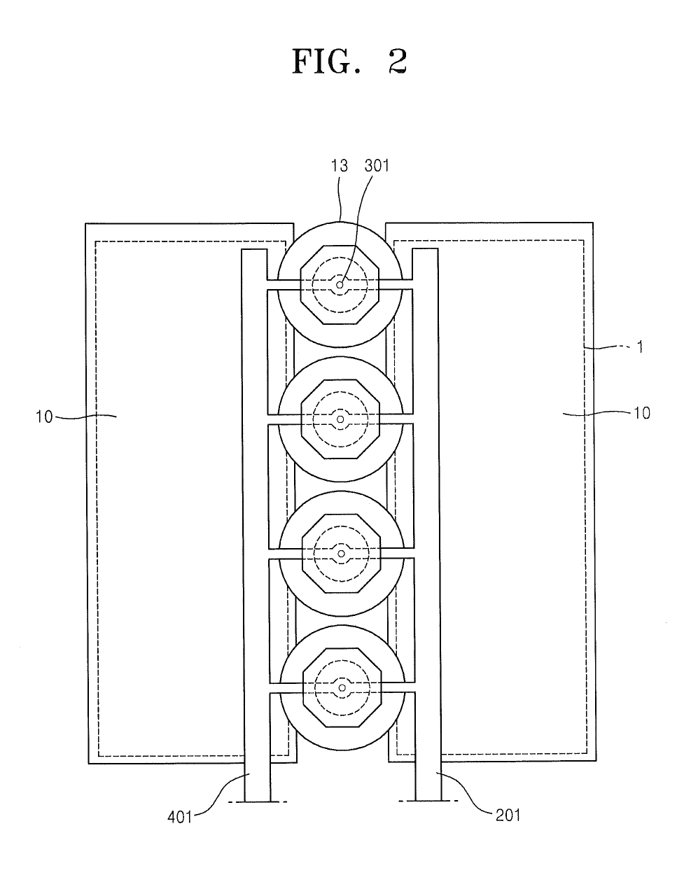

FIG. 1 is a cross-sectional view illustrating a molding apparatus according to an example embodiment of the inventive concepts, and FIG. 2 is a plan view illustrating the molding apparatus of FIG. 1.

First, as illustrated in FIGS. 1 and 2, the molding apparatus includes a mold 100, a pot 11, a compression gas injection unit 200, a fluid resin supplying unit 300, and a first vacuum pressure forming apparatus 400.

The mold 100 may be formed of a first die 10 and a second die 20 that are clamped, gripped or fastened to each other so that a cavity C and a runner R are formed therein.

The mold 100 may be of various types, and thus various molding products such as a plastic molding product may be manufactured using the mold 100. Preferably, as illustrated in FIGS. 1 and 2, the mold 100 may include a circuit substrate 1 in which a plurality of semiconductor chips 2 are mounted or disposed between the first die 10 and the second die 20.

The plurality of semiconductor chips 2 of FIG. 1 may be electrically or operatively connected to the circuit substrate 1 via a signal transfer medium 3 such as a wire. A fluid resin P may be firmly and completely filled or disposed between the semiconductor chips 2 formed in the cavity C and the signal transfer medium 3. The fluid resin P may be a high fluidity resin having a low viscosity so that a pressure difference is not large or minimized during transfer of the resin P.

Also, as illustrated in FIGS. 1 and 2, the pot 11 is connected to the runner R formed in the mold 100, and the fluid resin P is temporarily contained in the pot 11 before the resin P is transferred to the cavity C. Thus, the pot 11 is designed such that a sufficient amount of the resin P can be contained in the cavity C and the runner R.

The pot 11 may preferably be disposed or installed in the first die 10 so as to be connected to the runner R. A pot head 13 may be disposed or installed on the pot 11 so that the compression gas injection unit 200, the fluid resin supplying unit 300, and the first vacuum pressure forming apparatus 400 are integrally disposed or installed on the pot head 13 as illustrated in FIGS. 1 and 2.

Because the pot 11 and the pot head 13 can be detached or separated, the pot 11 may be replaced, restored or repaired. Additionally, the compression gas injection unit 200, the fluid resin supplying unit 300, and the first vacuum forming unit 400 may be easily replaced, restored or repaired.

Also, the pot 11 may preferably include a non-viscosity coating layer 12 that is disposed or formed on an inner wall of the pot 11. The non-viscosity coating layer 12 may allow for easy separation of the resin P so that the resin P does not remain on the inner wall of the pot 11.

The non-viscosity coating layer 12 may be disposed or formed of an organic material such as a silicon compound, a Teflon compound, or the like, an inorganic material such as a carbon compound, a diamond compound, etc., or other various types of coating layers such as a waterproof/water-repellent coating layer or a nano-coating layer that increases surface tension.

As illustrated in FIGS. 1, 2, and 6 the compression gas injection unit 200 supplies, injects or inputs a compression gas into the pot 11 such that the fluid resin P contained in the pot 11 is transferred to the cavity C and the runner R due to a gas pressure F. The compression gas injection unit 200 may be foamed of a compression gas supply pipe 201, a compression gas supply valve 202, a compression gas storage 203, and a control unit 30.

The compression gas supply pipe 201 is positioned or installed at a first side of the pot head 13 that is sealed on the pot 11 so as to supply the compression gas into the pot 11.

Also, the compression gas supply valve 202 is positioned or installed at the compression gas supply pipe 201, and selectively supplies the compression gas into the pot 11.

Also, the compression gas storage 203 is connected to the compression supply pipe 201.

Examples of the compression gas include not only air and carbon dioxide but also all kinds of gasses such as an inactive gas like compressed nitrogen, helium, neon, argon, krypton, xenon, radon gas, and the like.

Also, the control unit 30 applies a control signal to the compression gas supply valve 202 according to a program or a compression gas supply command. The control unit 30 may control the compression gas supply valve 202 via a molding method according to the inventive concepts, which will be described later, according to a series of programs, or control the compression gas supply valve 202 according to a command of a user using a separate input device (not shown).

The fluid resin supply unit 300 may supply the fluid resin P into the pot 11, and may include a fluid resin injection nozzle 301 and a dispenser 302.

The fluid resin injection nozzle 301 has a syringe-like form and is positioned or installed on a center or middle area of the pot head 13 that is positioned or installed and sealed on the pot 11 so as to supply, insert or inject the fluid resin P into the pot 11.

Also, the dispenser 302 is connected to the fluid resin injection nozzle 301 and supplies the fluid resin P thereto.

Also, the above-described control unit 30 applies a control signal to the dispenser 302 according to a program or a supply command, and may control the dispenser 302 via a molding method according to the embodiments of the inventive concepts, which will be described later, according to a series of programs, or by using an additional input device (not shown) according to a command of the user.

As illustrated in FIGS. 1 and 2, the first vacuum pressure forming apparatus 400 may include a first vacuum line 401, a first vacuum line open/close valve 402 and, a first vacuum pump 403 that are connected to the pot 11 and form a vacuum pressure in the cavity C, the runner R, and the pot 11 in the mold 100.

The first vacuum line 401 is positioned or installed at a second side of the pot head 13 that is positioned or installed and sealed on the pot 11 so that a vacuum pressure is generated in the pot 11.

Also, the first vacuum line open/close valve 402 is positioned or installed at the first vacuum line 401 and selectively opens or closes the first vacuum line 401.

Also, the first vacuum pump 403 is connected to the first vacuum line 401 and generates a vacuum pressure in the first vacuum line 401.

Also, the above-described control unit 30 applies a control signal to the first vacuum line open/close valve 402 according to a program or a command for forming a first vacuum pressure. The control unit 30 may control the first vacuum line open/close valve 402 according to example embodiments, a series of programs or methods of molding of the inventive concepts, which will be described later, or control the first vacuum line open/close valve 402 by using an additional input device (not shown) according to a command of the user.

Also, a plurality of individual control units (not shown) for controlling the compression gas injection unit 200, the fluid resin supplying unit 300, and the first vacuum pressure forming apparatus 400 may be installed. However, application of the control unit 30 of FIG. 1 that integrally controls the compression gas injection unit 200, the fluid resin supplying unit 300, and the first vacuum pressure forming apparatus 400 according to the molding methods of the inventive concepts, and according to a desired, required or predetermined order is preferable.

Hereinafter, an operation of the molding apparatus according to example embodiments of the inventive concepts will be described in detail with reference to a molding method of the inventive concepts.

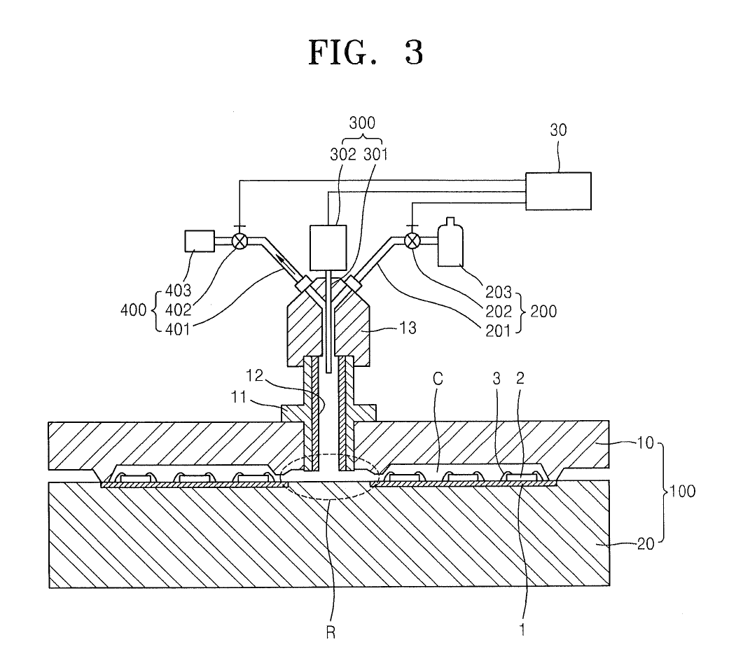

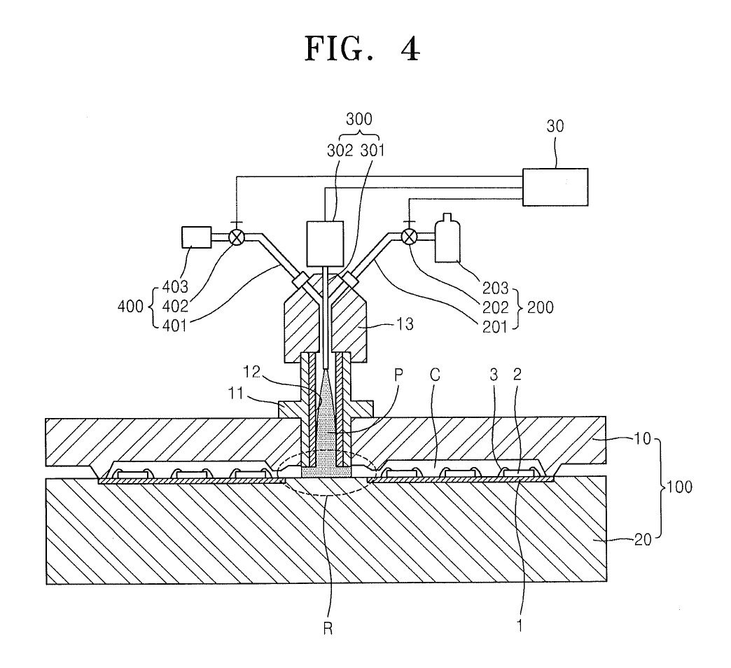

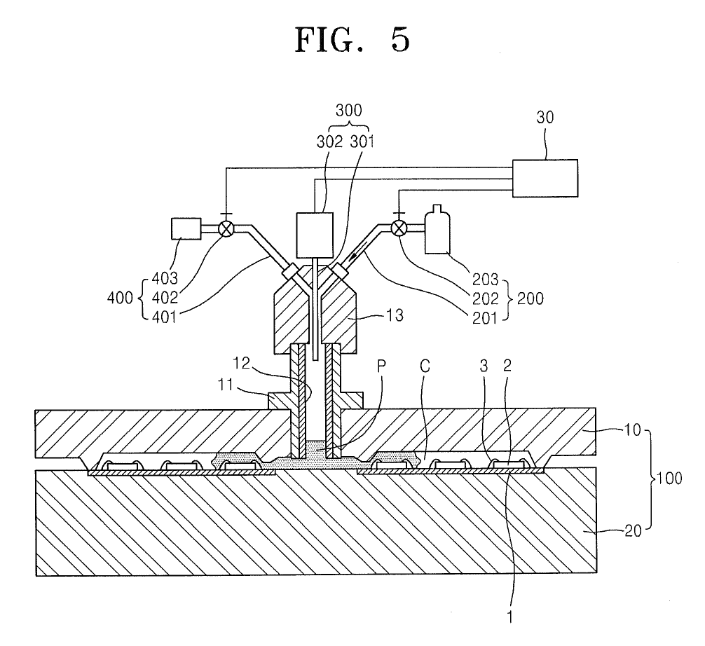

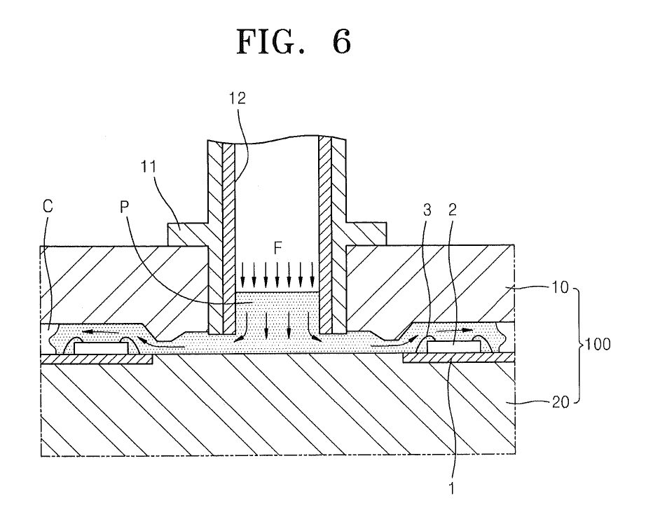

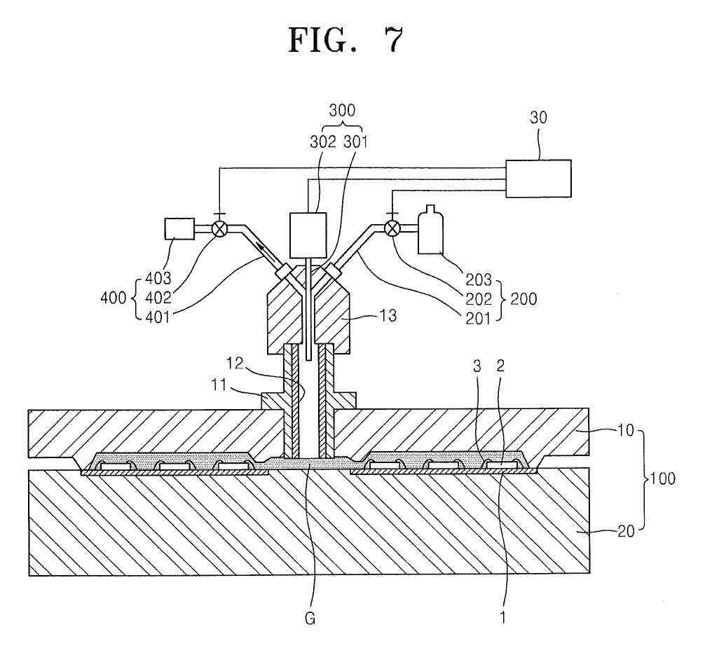

FIG. 3 is a cross-sectional view illustrating an operation of forming a vacuum pressure of the molding apparatus of FIG. 1. FIG. 4 is a cross-sectional view illustrating an operation of supplying a fluid resin in the molding apparatus of FIG. 1. FIG. 5 is a cross-sectional view illustrating an operation of injecting a compression gas in the molding apparatus of FIG. 1. FIG. 6 is an enlarged view illustrating how the compression gas in the molding apparatus of FIG. 5 works on the fluid resin. FIG. 7 is a cross-sectional view illustrating an operation of discharging a compression gas from the molding apparatus of FIG. 1.

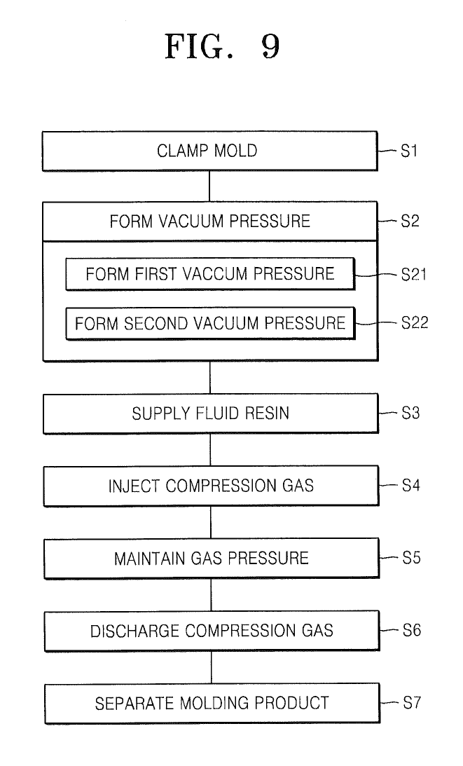

FIG. 9 is a block diagram illustrating a molding method according to an example embodiment of the inventive concepts.

As illustrated in FIG. 9, the molding method according to embodiments of the inventive concepts using the molding apparatus comprises clamping a mold (S1), forming a vacuum pressure (S2), supplying a fluid resin (S3), injecting a compression gas (S4), maintaining a gas pressure (S5), discharging a compression gas (S6), and separating a molding product (S7).

As illustrated in FIG. 3, in operation S1 of clamping a mold and operation S2 of forming a vacuum pressure, a first die 10 and a second die 20 of a mold 100 are fastened, gripped or clamped to each other such that a cavity C and a runner R are formed therein, and a vacuum pressure is formed in the cavity C, the runner R, and a pot 11.

The control unit 30 applies a valve open signal to the first vacuum line open/close valve 402 so as to form a vacuum pressure in the cavity C, the runner R, and the pot 11.

Accordingly, remaining foreign materials and remaining air in the cavity C, the runner R, and the pot 11 may be minimized or removed so that transfer of the fluid resin P is not hindered by the cavity C, the runner R, and the pot 11 in subsequent processes.

As illustrated in FIG. 4, in operation S3 of supplying a fluid resin, of FIG. 9, a fluid resin P is supplied to the pot 11 which is connected to the runner R in the mold 100.

The control unit 30 may apply a fluid resin supply signal to the dispenser 302 to thereby supply the fluid resin P to the pot 11.

Accordingly, a sufficient amount of the fluid resin P may be temporarily contained in the pot 11 before the fluid resin P is transferred to the cavity C.

As illustrated in FIG. 5, in operation S4 of injecting a compression gas of FIG. 9, a compression gas is inserted or injected into the pot 11 such that the fluid resin P contained in the pot 11 is displaced or transferred to the cavity C and the runner R due to a gas pressure.

The control unit 30 may apply a valve open signal to the compression gas supply valve 202 so as to supply a compression gas to the pot 11.

Accordingly, as illustrated in FIG. 6, the fluid resin P contained in the pot 11 may be displaced or transferred towards the cavity C and the runner R due to the gas pressure F.

As illustrated in FIG. 7, in operation S5 of maintaining the gas pressure and operation S6 of discharging the compression gas illustrated in FIG. 9, the gas pressure of the pot 11 is maintained until the fluid resin P filled in the cavity C and the runner R is solidified, rigid or hardened. When the fluid resin P filled in the cavity C and the runner R is solidified, rigid or hardened, the compression gas in the pot 11 is discharged to the outside.

The control unit 30 applies a valve close signal to the compression gas supply valve 202 to maintain the gas pressure in the pot 11 until the fluid resin P is sufficiently solidified, rigid or hardened, and when the fluid resin P is sufficiently solidified, rigid or hardened, a valve open signal is applied to the first vacuum line open/close valve 402 to thereby discharge the compression gas in advance for separation of the mold 100.

Accordingly, the gas pressure is maintained when the fluid resin P is solidified, rigid or hardened, and thus a dense, high quality molding product may be manufactured.

Although not shown in FIG. 9, in operation S7 of separating a molding product, the first die 10 and the second die 20 of the mold 100 are unclamped, detached or opened and the molded molding product G is detached or separated from the mold 100.

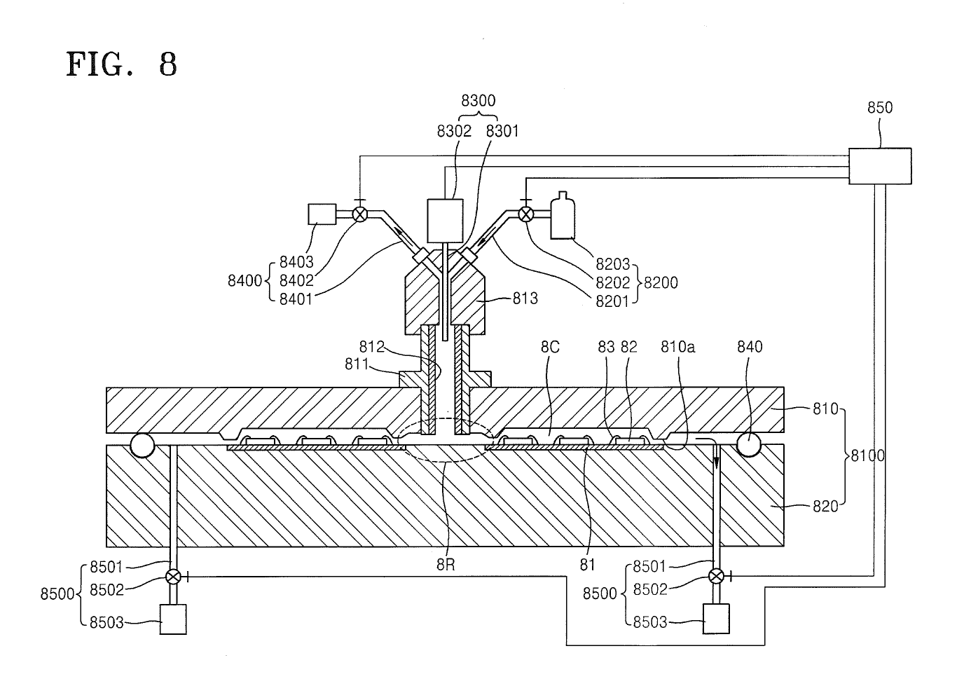

FIG. 8 is a cross-sectional view illustrating a molding apparatus according to at least one other embodiment of the inventive concepts.

As illustrated in FIG. 8, the molding apparatus may further include a sealing member 840 and a second vacuum pressure forming apparatus 8500.

The sealing member 840 is fixed or installed between the first die 810 and the second die 820 so that a vent hole 810a formed between the first die 810 and the second die 20 is sealed when the first die 810 and the second die 820 are griped, fastened or clamped to each other.

Also, the second vacuum pressure forming apparatus 8500 is fixed or installed between the vent hole 810a and the sealing member 840 and the second vacuum pressure forming apparatus 8500 forms a vacuum pressure through the vent hole 810a into the cavity 8C, the runner 8R, and the pot 811 of the mold 8100. The second vacuum pressure forming apparatus 8500 may include a second vacuum line 8501, a second vacuum line open/close valve 8502, a second vacuum pump 8503, and a control unit 850.

The second vacuum line 8501 is fixed or installed between the vent hole 810a and the sealing member 840 such that a vacuum pressure is formed between the vent hole 810a and the sealing member 840.

Also, the second vacuum line open/close valve 8502 is fixed or installed on the second vacuum line 501, and selectively opens/closes the second vacuum line 8501.

Also, the second vacuum pump 8503 is connected to the second vacuum line 501 and generates a vacuum pressure in the second vacuum line 8501.

Also, the control unit 850 applies a control signal to the second vacuum line open/close valve 8502 according to a command for forming a second vacuum pressure, and may control the second vacuum line open/close valve 8502 using a molding methods of the inventive concepts, which will be described later, according to a series of programs, or control the second vacuum line open/close valve 8502 according to a command of a user using a separate input device (not shown).

The control unit 850 simultaneously controls the first vacuum line open/close valve 8402 and the second vacuum line open/close valve 8502 in operation S2 of forming a vacuum pressure.

That is, as illustrated in FIG. 9, operation S2 of fondling a vacuum pressure may include operation S21 of forming a first vacuum pressure, in which the first vacuum pressure forming apparatus 8400 installed at the pot 811a. The first vacuum pressure forming apparatus 8400 is used to form vacuum pressure into the cavity 8C, the runner 8R, and the pot 811 in the mold 8100. Operating S2 of forming a vacuum pressure may further include operation S22 of forming a second vacuum pressure. In operation S22, the second vacuum pressure forming apparatus 8500 that is fixed or installed between the vent hole 810a formed between the first die 810 and the second die 820 when the first die 810 and the second die 820 are gripped, fastened or clamped to each other. The sealing member 840 fixed installed between the first die 810 and the second die 820. In Operation S22 the second vacuum pressure forming apparatus 8500 is used to form a vacuum pressure through the vent hole 10a into the cavity 8C, the runner 8R, and the pot 811 in the mold 8100.

Accordingly, a vacuum pressure may be formed in a direction towards the pot 811 around the cavity 8C, and a vacuum pressure is formed in a double-fold manner in the direction towards the vent hole 810a when inserting or injecting the fluid resin P so as to more quickly and more easily transfer and penetrate the fluid resin. Thus, the productivity of the molding method may be improved.

While the inventive concepts have been particularly shown and described with reference to example embodiments thereof, it will be understood that various changes in form and details may be made therein without departing from the spirit and scope of the following claims.

What is claimed is:

1. A molding apparatus, comprising:
a mold including a cavity and a runner;
a pot connected to the runner of the mold, wherein a fluid resin is contained in the pot; and
a compression gas injection device configured to inject a compression gas into the pot such that the fluid resin contained in the pot is transferred to the cavity and the runner due to.

2. The molding apparatus of claim 1, wherein the mold includes a first die and a second die clamped to each other, and the first die and the second die define the cavity and the runner.

3. The molding apparatus of claim 2, wherein the pot is on the first die so as to be connected to the runner.

4. The molding apparatus of claim 1, wherein the compression gas injection device comprises:
a compression gas supply pipe connected to the pot, the compression gas supply pipe configured to supply a compression gas into the pot;
a compression gas supply valve at the compression gas supply pipe, the compression gas supply valve configured to selectively supply the compression gas;
a compression gas storage device that is connected to the compression gas supply pipe, the compression gas storage device configured to store the compression gas; and
a control device configured to apply a control signal to the compression gas supply valve according to a program or a compression gas supply command.

5. The molding apparatus of claim 1, further comprising:
a fluid resin supply device configured to supply the fluid resin into the pot.

6. The molding apparatus of claim 5, wherein the fluid resin supply device comprises:
a fluid resin injection nozzle connected to the pot, and the fluid resin injection nozzle configured to inject the fluid resin into the pot;
a dispenser that is connected to the fluid resin injection nozzle, and the dispenser is configured to supply the fluid resin into the fluid resin injection nozzle; and
a control device configured to apply a control signal to the dispenser according to a program or a fluid resin supply command.

7. The molding apparatus of claim 1, further comprising:
a first vacuum pressure forming apparatus that is connected to the pot, and the first vacuum pressure forming apparatus configured to form a first vacuum pressure in the cavity, the runner, and the pot of the mold.

8. The molding apparatus of claim 7, wherein the first vacuum pressure forming apparatus comprises:
a first vacuum line that is connected to the pot so that the first vacuum pressure is formed in the pot;
a first vacuum line valve on the first vacuum line, and the first vacuum line is configured to selectively open and close the first vacuum line;
a first vacuum pump that is connected to the first vacuum line, the first vacuum pump is configured to generate the first vacuum pressure in the first vacuum line; and
a control unit configured to apply a control signal to the first vacuum line valve according to a program or a command for forming the first vacuum pressure.

9. The molding apparatus of claim 8, further comprising: a first die and a second die clamped to each other, and the first die and the second die define the cavity and the runner;
a sealing member between the first die and the second die so that a vent hole formed between the first die and the second die is sealed when the first die and the second die are clamped to each other; and
a second vacuum pressure forming apparatus between the vent hole and the sealing member, and the second vacuum pressure forming apparatus is configured to form a second vacuum pressure in the cavity, the runner, and the pot of the mold through the vent hole.

10. The molding apparatus of claim 9, wherein the second vacuum pressure forming apparatus comprises:
a second vacuum line between the vent hole and the sealing member so that the second vacuum pressure is formed between the vent hole and the sealing member;
a second vacuum line valve on the second vacuum line, and the second vacuum line is configured to selectively open and close the second vacuum line;
a second vacuum pump that is connected to the second vacuum line, and the second vacuum pump is configured to generate the second vacuum pressure in the second vacuum line; and
a control unit configured to apply a control signal to the second vacuum line valve according to a program or a command for forming the second vacuum pressure.

11. The molding apparatus of claim 1, wherein the mold is a mold for molding semiconductors, in which a circuit board including a semiconductor chip is mounted between a first die and a second die.

12. The molding apparatus of claim 1, wherein a non-viscosity coating layer is formed on an inner wall of the pot so that the fluid resin is easily separated from the inner wall of the pot.

13. A method of molding, the method comprising:
clamping a mold such that a first die and a second die of the mold are clamped to each other and a cavity and a runner are formed in the mold;
supplying a fluid resin into a pot that is connected to the runner in the mold; and
injecting a compression gas into the pot such that the fluid resin contained in the pot is transferred to the cavity and the runner due.

14. The method of claim 13, further comprising:
forming at least one vacuum pressure the cavity, the runner, and the pot after clamping the mold and before supplying the fluid resin into the pot.

15. The method of claim 14, wherein the forming the at least one vacuum pressure comprises:
forming a first vacuum pressure into the cavity, the runner, and the pot of the mold by using a first vacuum pressure forming apparatus in the pot

16. The method of claim 15, wherein the forming the at least one vacuum pressure includes:
forming a second vacuum pressure by using a second vacuum pressure forming apparatus that is installed in a vent hole formed between the first die and the second die when the first die and the second die are clamped to each other with a sealing member installed between the first die and the second die, wherein a vacuum pressure is formed through the vent hole into the cavity, the runner, and the pot formed in the mold.

17. The method of claim 13, further comprising:
maintaining a gas pressure of the compression gas in the pot until the fluid resin filled in the cavity and the runner is hardened.

18. The method of claim 13, further comprising:
discharging the compression gas in the pot when the fluid resin filled in the cavity and the runner is hardened; and
opening the first die and the second die of the mold; and
separating the molded molding product from the mold.

19. The method of claim 18, wherein the molded molding includes a semiconductor device.
